(19) United States
(12) Patent Application Publication
(10) Pub. No.: US 2012/0123781 A1
(43) Pub. Date: May 17, 2012

(54) TOUCH SCREEN DEVICE FOR ALLOWING BLIND PEOPLE TO OPERATE OBJECTS DISPLAYED THEREON AND OBJECT OPERATING METHOD IN THE TOUCH SCREEN DEVICE

(76) Inventors: Kun Park, Seongnam-si (KR); Yong Suk Pak, Anyang-si (KR)

(21) Appl. No.: 13/025,598

(22) Filed: Feb. 11, 2011

(30) Foreign Application Priority Data
Nov. 11, 2010 (KR) 10-2010-0111844

(51) Int. Cl. G06F 3/041; G10L 13/08

(52) U.S. Cl. 704/260; 345/173; 704/E13.001

(57) ABSTRACT

A touch screen device allowing blind people to operate objects displayed thereon and an object operating method in the touch screen device are provided. The touch screen device includes a touch sensing unit generating key values corresponding to touched ‘touch position's of a virtual keyboard for controlling application software being executed, the number of touches and touch time and transmitting the key values to the application software when sensing touches of the virtual keyboard while the virtual keyboard is activated, an object determination unit reading text information of a focused object using hooking mechanism when the application software is executed based on the key values received from the touch sensing unit and the object among objects included in the application software is focused, and a speech synthesis unit converting the text information read by the object determination unit into speech data using a text-to-speech engine and outputting the speech data.

### CROSS-REFERENCE TO RELATED APPLICATION

This application claims the benefit under 35 U.S.C. §119(a) of Korean Patent Application No. 10-2010-0111844, filed on Nov. 11, 2010, the entire disclosure of which is incorporated herein by reference for all purposes.

### BACKGROUND OF THE INVENTION

1. Field of the Invention

The present invention relates to a touch screen device that allows blind people to operate objects displayed thereon and an object operating method in the touch screen device, and more particularly, to a touch screen device that allows blind people to operate objects displayed thereon and an object operating method in the touch screen device for generating key values corresponding to touched ‘touch position's of a virtual keyboard, the number of touches and touch time and transmitting the key values to application software being executed when touches of the virtual keyboard for controlling the application software are sensed while the virtual keyboard is activated, reading text information of a focused object using hooking mechanism when the application software is executed based on the key values and the object among objects included in the application software is focused, converting the text information into speech data using a text-to-speech engine and outputting the speech data.

2. Background of the Related Art

Generally, a touch screen device provides an interface by which a user touches an icon displayed on the touch screen device with a finger or a pointer to input a command or information. The touch screen device is a kind of input device and is applied to various terminals such as a cellular phone, smart phone, ATM (Automatic Teller Machine), palm PC, PDA (Personal Digital Assistants), etc.

Methods of inputting a character and selecting an object through the touch screen device are divided into a cursive script handling method and a soft keyboard handling method. In the cursive script handling method, a user writes letters on the screen with a stylus pen as if he writes letters on paper with a pen and selects an object on the screen. According to the soft keyboard handling method, a keyboard having a user interface in the form of a general keyboard is displayed on the screen and a user inputs letters according to pen click and selects an object on the screen.

There is ‘VOICE OVER’ of iPhone, which is a touch screen that can be accessed by blind people in a pull touch manner. This pull-touch type touch screen outputs a voice when a user focuses an object displayed on the screen with a finger and requires the blind people who cannot estimate the position and direction of the object to perform an accidental operation through a random action.

However, the blind people do not know the position and direction of an object to be touched because they cannot see the touch screen. Accordingly, the blind people cannot input letters or select and operate an object on the screen in a touch manner.

### SUMMARY OF THE INVENTION

Accordingly, the present invention has been made in view of the above-mentioned problems occurring in the prior art, and it is a primary object of the present invention to provide a touch screen device that allows blind people to operate objects displayed thereon and an object operating method in the touch screen device for allowing the blind people to freely select and execute an object displayed on the touch screen based on information on the object and a previously standardized virtual keyboard.

To accomplish the above object of the present invention, according to an aspect of the present invention, there is provided a touch screen device comprising a touch sensing unit generating key values corresponding to touched ‘touch position's of a virtual keyboard for controlling application software being executed, the number of touches and touch time and transmitting the key values to the application software when sensing touches of the virtual keyboard while the virtual keyboard is activated; an object determination unit reading text information of a focused object using hooking mechanism when the application software is executed based on the key values received from the touch sensing unit and the object among objects included in the application software is focused; and a speech synthesis unit converting the text information read by the object determination unit into speech data using a text-to-speech engine and outputting the speech data.

The virtual keyboard may include a predetermined number of ‘touch position's arranged therein, may be not visually displayed on the screen and may operate in the background.

The object may be a component of the application software and the text information of the object includes the name, type and state of the object represented in a text.

When the touch sensing unit senses a touch of a ‘touch position’ to which a key value for a compass mode is allocated, the touch sensing unit requests the speech synthesis unit to output a voice message saying ‘compass mode’ and, when the touch sensing unit senses a touch of another ‘touch position’ during the touch of the ‘touch position’ of the compass mode, the touch sensing unit may generate a key value corresponding to the newly touched ‘touch position’ and transmit the key value to the application software.

According to another aspect of the present invention, there is provided a method of operating an object displayed on a touch screen device by a blind person, comprising the steps of generating key values corresponding to touched ‘touch position's of a virtual keyboard for controlling application software being executed, the number of touches and touch time and transmitting the key values to the application software when touches of the virtual keyboard are sensed while the virtual keyboard is activated; reading text information of a focused object using hooking mechanism when the application software is executed based on the key values and the object among objects included in the application software is focused; and converting the read text information into speech data using a TTS engine and outputting the speech data.

The step of generating the key values and transmitting the key values to the application software may comprise the steps of outputting a voice message saying ‘compass mode’ when a user touches a specific ‘touch position’ for the compass mode; and when a touch of another ‘touch position’ is sensed in the compass mode, generating a key value corresponding to the newly touched ‘touch position’ and transmitting the key value to the application software being executed.

According to the present invention, blind people can operate an object displayed on the touch screen based on information of the object and the previously standardized virtual keyboard irrespective of the position and direction of the object so as to freely select and execute the object.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a block diagram illustrating a configuration of a touch screen device that allows blind people to operate an object displayed thereon according to an embodiment of the present invention;

FIG. 2 is a flowchart illustrating a method of operating an object displayed on the touch screen device by a blind person according to an embodiment of the present invention; and

FIG. 3 illustrates an exemplary virtual keyboard according to an embodiment of the present invention.

### DETAILED DESCRIPTION OF THE PREFERRED EMBODIMENT

Hereinafter, the present invention will be described in detail by explaining preferred embodiments of the invention with reference to the attached drawings.

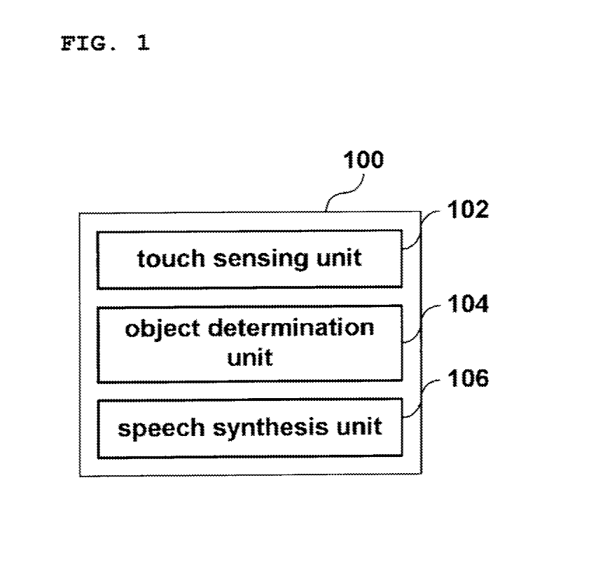

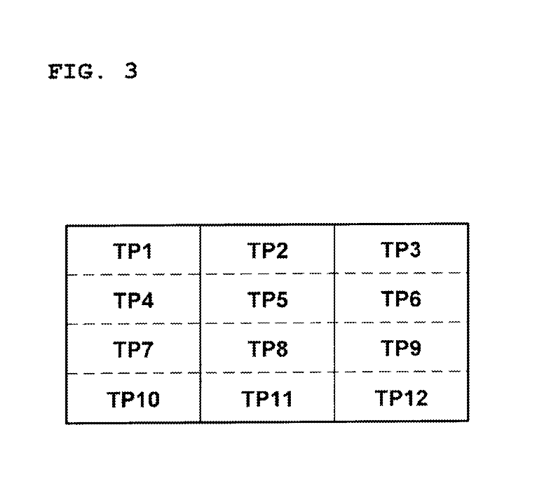

FIG. 1 is a block diagram illustrating a configuration of a touch screen device 100 that allows blind people to operate objects displayed thereon according to an embodiment of the present invention and FIG. 3 illustrates an exemplary virtual keyboard according to an embodiment of the present invention.

Referring to FIG. 1, the touch screen device 100 includes a touch sensing unit 102, an object determination unit 104 and a speech synthesis unit 106.

When the touch sensing unit 102 senses touches of a virtual keyboard while the virtual keyboard for controlling application software being executed is activated, the touch sensing unit 102 generates key values corresponding to ‘touch position's of the touched virtual keyboard, the number of touches and touch time and transmits the key values to application software being executed.

Here, the application software being, executed means application software currently visually displayed on the touch screen and is designed in architecture capable of receiving an enter value, a direction key value and a character key value if the application software is executed in conventional operation systems such as Windows, Android, MACOS and Linux. That is, the application software means generally used software and is generally designed in architecture capable of receiving key values. Furthermore, the application software does not use any mechanism to be controlled besides receiving/transmitting key values from/to the virtual keyboard in advance for interaction between the application software and the virtual keyboard.

The virtual keyboard, which has a structure in which a predetermined number of ‘touch position's are arranged, is not visually displayed on the screen and operates in the background of OS level.

A virtual keyboard with ‘3 by 4’ ‘touch position's is explained as an example. In this case, the virtual keyboard is segmented into 3-by-4 sections corresponding to a checkerboard pattern and has a size of three sections in width and four sections in length. The segmented sections mean a touch range and a lattice is not actually displayed on the touch screen.

That is, there are 12 ‘touch position's corresponding to the 3-by-4 touch sections, and the boundaries of the touch sections do not have ineffective regions and thus only 12 effective touches work. In addition, the ‘touch position's are respectively given identification numbers, for example, TP1, TP2, TP3, TP4, TP5, TP6, TP7, TP8, TP9, TP10, TP11 and TP12, according to arrangement order.

Furthermore, the virtual keyboard is composed of “AREA KEYPAD”, “FUNCTION KEYPAD”, “HANGEUL KEYPAD”, “ENGLISH KEYPAD”, “NUMERAL KEYPAD”, SIGN KEYPAD”, “HOT ENGLISH KEYPAD” and “HOT NUMERAL KEYPAD”. The keypads are classified according to purpose, and thus a desired keypad can be selected depending on the circumstances.

Methods of touching the virtual keyboard include touching a corresponding ‘touch position’ once, continuously touching a corresponding ‘touch position’ twice, continuously touching a corresponding ‘touch position’ three times, pressing a corresponding ‘touch position’ for longer than 0 second, pressing a corresponding ‘touch position’ for longer than 1 second, pressing a corresponding ‘touch position’ for longer than 2 seconds, and pressing a corresponding ‘touch position’ for longer than 3 seconds. Furthermore, “dragging a finger from side to side”, “dragging a finger up and down” and “simultaneous touching using three fingers” are related to additional functions.

When the application software is executed based on the key values received from the touch sensing unit 102 and an object among objects included in the application software is focused, the object determination unit 104 reads text information of the focused object using hooking mechanism.

That is, the application software is executed according to the key values received from the touch sensing unit 102. When an object among the whole objects included in the application software is activated or focused as a result of the execution of the application software, the object determination unit 104 reads text information of the activated or focused object using the hooking mechanism.

Here, the object, a component of the application software, is not generated by the application software and is included in the application software. For example, the object corresponds to a button, a file list, an edition window, a combo box, etc. The text information of the object includes the name, type and state of the object represented in a text.

The hooking mechanism is supported through API in operating systems such as Windows ce, Windows XP, Windows 2000 and LINUX and a hooking component includes the name and type of an object of the currently executed application software, displayed on the screen, and text characters representing the object.

The touch screen device can automatically change the keypad type of the virtual keyboard according to the on-screen display name, type and processor name of the focused object among all the objects included in the activated application software based on previously stored databases. For example, when the focused object is ‘file list’, the keypad type of the virtual keyboard is changed to ‘AREA KEYPAD’ and keys of the ‘touch position's, are transmitted as direction key values. When the focused object is ‘edition window’, the keypad of the virtual keyboard is changed to ‘HANGEUL/ENGLISH KEYPAD’ and the keys of ‘touch position's are transmitted as character key values. In the case of telephone or calculator software, the keypad of the virtual keyboard is changed to ‘NUMERAL KEYPAD’ and touched keys are transmitted as numeral values.

When the touch sensing unit 102 senses a touch of a ‘touch position’ to which a key value for a compass mode is allocated, the touch sensing unit 102 requests the speech synthesis unit 106 to output a voice message saying ‘compass mode’. When the touch sensing unit 102 senses a touch of another ‘touch position’ in the compass mode, the touch sensing unit 102 generates a key value corresponding to the touched ‘touch position’ and transmits the key value to the application software being executed.

A virtual keyboard having 3-by-4 ‘touch position's, as shown in FIG. 3, will now be explained.

Referring to FIG. 3, TP1, TP2, TP3, TP4, TP5, TP6, TP7, TP8, TP9, TP10, TP11 and TP12 are respectively allocated to the 12 ‘touch position's according to arrangement order.

If a user touches the ‘touch position’ TP5 located at the center of the virtual keyboard and maintains the touch for a predetermined time, the touch sensing unit 102 determines that the touch screen device is in the compass mode.

Here, if a user's finger moves on the ‘touch position's of the virtual keyboard while touching the ‘touch position's, a normal signal sound, light vibration or a voice message saying ‘right position’ is output when the user's finger passes the ‘touch position’ TP5.

When the user touches the ‘touch position’ TP5 with a pointer and maintains the touch for a predetermined time or continuously maintains the touched state, the touch screen device enters ‘compass mode’. Here, the pointer is a user's finger capable of touching the virtual keyboard.

The compass mode is a function that allows a first pointer touching the ‘touch position’ TP5 to maintain the touch and does not obstruct touching of a second pointer. When the user touches another ‘touch position’ while the compass mode is maintained, the touch sensing unit 102 generates a key value corresponding to the other ‘touch position’ and transmits the key value to the application software being executed.

That is, when the user touches the ‘touch position’ TP1, TP2, TP3, TP4, TP6, TP7, TP8, TP9, TP10, TP11 and TP12 using the second pointer in the compass mode, key values corresponding to the ‘touch position's are transmitted. Meantime, it is not easy to touch the ‘touch position's TP5 and TP6 in the compass mode. In this case, the finger touching the virtual keyboard is taken off the virtual keyboard to cancel the compass mode, and then the ‘touch position's TP5 and TP6 are touched with a finger and the finger is taken off the ‘touch position's TP5 and TP6 within a predetermined time. This can be achieved because a user's finger supports the central ‘touch position’ TP5 to become a axis of finger movement. A blind person can recognize the direction (8 directions) of an object although he cannot recognize the position of the object. The blind person supports a axis point of the directions with a finger, and thus the blind person can easily touch the ‘touch position's TP5 and TP6.

The virtual keyboard has key values previously set to ‘touch position's according to keypad type. For example, when the virtual keyboard is activated as character keypads, keys of the ‘touch position's are set to key values of character elements in such a manner that TP1=“a” (touching TP1 corresponds to pressing “a” of QWERTY keyboard), TP1, TP1=“b” (continuously touching TP1 and TP1 within a restricted time corresponds to pressing “b” of QWERTY keyboard), TP1, TP2=“c” (continuously touching TP1 and TP2 within a restricted time corresponds to pressing “c” of QWERTY keyboard), and TP8=“(DOWN)” (touching TP8 corresponds to pressing “DOWN key” of QWERTY keyboard).

The speech synthesis unit 106 converts the text information of the object, read by the object determination unit 104, into speech data using a TTS (Text to Speech) engine.

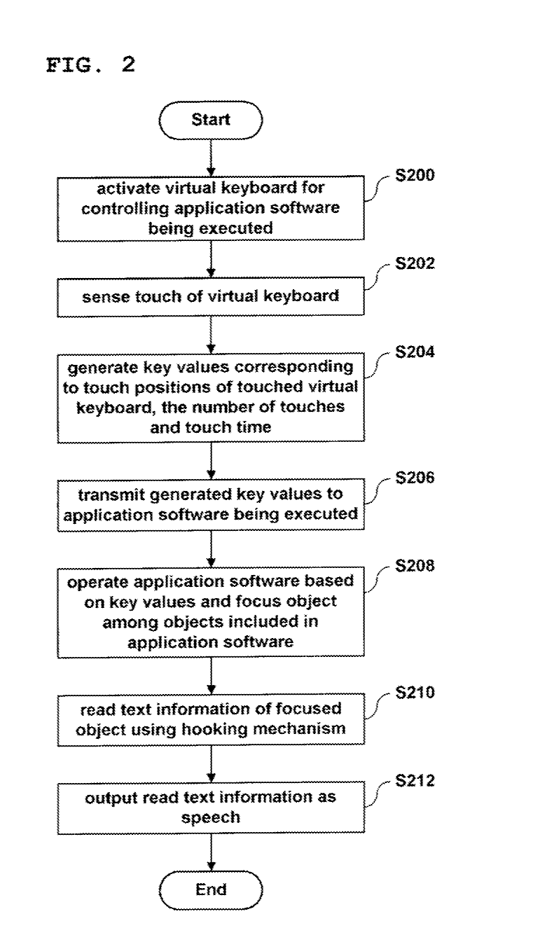

FIG. 2 is a flowchart illustrating a method of operating an object displayed on the touch screen device by a blind person according to an embodiment to the present invention.

Referring to FIG. 2, when a virtual keyboard for transmitting key values to application software being executed is activated in step S200 and touches of the virtual keyboard are sensed in step S202, the touch screen device generates key values corresponding to touched ‘touch position's of the virtual keyboard, the number of touches and touch time in step S204 and transmits the key values to the application software being executed in step S206.

Here, if a ‘touch position’ to which a key value for the compass mode is allocated is touched, the touch screen device maintains the compass mode while outputting a voice message saying ‘compass mode’. When another ‘touch position’ is touched in the compass mode, the touch screen device generates a key value corresponding to the other ‘touch position’ and transmits the key value to the application software being executed.

When the application software is executed based on the key values received from the touch screen device and an object among objects included in the application software is focused in step S208, the touch screen device reads text information of the focused object using the hooking mechanism in step S210. Here, the touch screen device reads the name and type of the focused object and text characters corresponding to the focused object, displayed on the screen, using the hooking mechanism.

The touch screen device converts the text information of the object into speech data using a TTS engine and outputs the speech data in step S212.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A touch screen device comprising:
a touch sensing unit generating key values corresponding to touched ‘touch position's of a virtual keyboard for controlling application software being executed, the number of touches and touch time and transmitting the key values to the application software when sensing touches of the virtual keyboard while the virtual keyboard is activated;
an object determination unit reading text information of a focused object using hooking mechanism when the application software is executed based on the key values received from the touch sensing unit and the object among objects included in the application software is focused; and
a speech synthesis unit converting the text information read by the object determination unit into speech data using a text-to-speech engine and outputting the speech data.

2. The touch screen device of claim 1, wherein the virtual keyboard includes a predetermined number of ‘touch position's arranged therein, is not visually displayed on the screen and operates in the background.

3. The touch screen device of claim 1, wherein the object is a component of the application software.

4. The touch screen device of claim 1, wherein the text information of the object includes the name, type and state of the object represented in a text.

5. The touch screen device of claim 1, wherein when the touch sensing unit senses a touch of a ‘touch position’ to which a key value for a compass mode is allocated, the touch sensing unit requests the speech synthesis unit to output a voice message saying ‘compass mode’ and, when the touch sensing unit senses a touch of another ‘touch position’ during the touch of the ‘touch position’ of the ‘compass mode’, the touch sensing unit generates a key value corresponding to the newly touched ‘touch position’ and transmits the key value to the application software.

6. A method of operating an object displayed on a touch screen device by a blind person, comprising the steps of:
generating key values corresponding to touched ‘touch position's of a virtual keyboard for controlling application software being executed, the number of touches and touch time and transmitting the key values to the application software when touches of the virtual keyboard are sensed while the virtual keyboard is activated;
reading text information of a focused object using hooking mechanism when the application software is executed based on the key values and the object among objects included in the application software is focused; and
converting the read text information into speech data using a TTS engine and outputting the speech data.

7. The method of claim 6, wherein the step of generating the key values and transmitting the key values to the application software comprises the steps of:
outputting a voice message saying ‘compass mode’ when a user touches a specific ‘touch position’ for the compass mode; and
when a touch of another ‘touch position’ is sensed in the compass mode, generating a key value corresponding to the newly touched ‘touch position’ and transmitting the key value to the application software being executed.
